(19) United States
(12) Patent Application Publication
(10) Pub. No.: US 2004/0104093 A1
(43) Pub. Date: Jun. 3, 2004

(54) Pressure force transmission plate for a friction clutch

(75) Inventors: Horst Friedrich, Aidhausen (DE); Werner Selzam, Wipfeld (DE)

Correspondence Address: COHEN, PONTANI, LIEBERMAN & PAVANE, 551 FIFTH AVENUE, SUITE 1210, NEW YORK, NY, 10176, US

(73) Assignee: Sachs Race Engineering GmbH

(21) Appl. No.: 10/638,639

(22) Filed: Aug. 11, 2003

(30) Foreign Application Priority Data
Aug. 10, 2002 (DE) 102 36 841.4

(51) Int. Cl. F16D 13/52

(52) U.S. Cl. 192/70.2

(57) ABSTRACT

A pressure force transmission plate for a friction clutch includes a ring-like plate body which on a first axial side, with respect to a plate axis of rotation A, has a force transmission surface curved at least in a radial region.

### BACKGROUND OF THE INVENTION

1. Field of the Invention

The present invention relates to a pressure force transmission plate for a friction clutch and to a friction clutch comprising such a pressure force transmission plate.

2. Description of the Related Art

In friction clutches such as, for example, those used in motor racing, the pressure force provided by a force accumulator designed as a diaphragm spring is transmitted by a pressure plate of ring-like design to the friction members (i.e., friction disks) which are or are capable of being brought into frictional interaction with one another. Due to the high loads occurring in motor racing, it is not possible to maintain in the region of the various friction members the lining resiliences which are provided in the case of conventional clutch disks. However, lining resiliences of this type allow an engagement state to be reached, during the engagement operation of the clutch, more or less gradually and to avoid a jolt-like spontaneous rise in the clutch torque. Accordingly, a comparatively high degree of comfort can be achieved in normal vehicle construction. Motor racing also requires such a gradually occurring closing of the clutch since the avoidance of a spontaneous or jolt-like rise in the clutch torque allows markedly higher accuracy in the setting of the clutch torque. The higher accuracy is advantageous particularly in the starting phase during which stage the desired slip of the driving wheels in the range of 10% to 15% can be set with substantially greater accuracy by corresponding clutch actuation. Furthermore, the surging of the engine rotational speed possibly occurring as a result of too rapid a closing of the clutch can be avoided. So that, even with regard to motor racing clutches, an elasticity corresponding to the functioning of the lining resilience of conventional clutches is desired. To accomplish this, the pressure plate may have an umbrella-like design in the region of its force transmission surface. That is, the pressure plate may have a profile inclined from radially inward to radially outward with respect to a plane orthogonal to the axis of rotation. As a result, during the engagement of the clutch, a deformation of the pressure plate is induced, simultaneously with an increase in the counterforce provided by the pressure plate. It has been shown that in such pressure plates designed with a force transmission surface running obliquely with respect to the plane referred to, there is a more or less linear rise in the counterforce, specifically until the pressure plate comes to bear completely. In the phase in which an elastic deformation of the pressure plate is therefore still possible, a comparatively accurate jolt-avoiding actuation of the clutch may be carried out. When the maximum deformation state of the pressure plate is reached, however, a spontaneous rise in the clutch torque nevertheless arises, since there is no longer any compensating elasticity in the region of the pressure plate.

### SUMMARY OF THE INVENTION

The object of the present invention is to provide a pressure force transmission plate for a friction clutch and a friction clutch having such a pressure force transmission plate, in which an improved meterability of the clutch torque when coupling operations are carried out can be obtained.

The object is achieved by a pressure force transmission plate for a friction clutch which includes a ring-like plate body which on a first axial side of the pressure plate, with respect to a plate axis of rotation, has a force transmission surface that is curved at least in a radially extending region thereof.

The curved configuration of the force transmission surface of a pressure force transmission plate does not produce a linear rise in counterforce during the deformation thereof. Instead, a progressive force rise which becomes markedly steeper at the approach to maximum deformation is exhibited by the curved configuration of the force transmission surface. Consequently, when coupling operations are preformed, no abrupt rise in the clutch torque will occur at the approach to the maximum deformation state of this plate. The meterability of the clutch torque is thereby markedly improved, above all in the initial phase of the coupling operation.

A second axial side of the pressure plate may, for example, have a force application portion for introducing a force provided by a force accumulator. In this case, therefore, the pressure force transmission plate according to the invention is to be considered, in general terms, as that component which in a friction clutch absorbs the pressure force from a force accumulator and then conducts it to further components.

So that the desired deformation can be obtained in a defined way, the force application portion may be arranged, in the radial direction, in one radial end region of the force transmission surface. An axial distance between the force transmission surface and the force application portion increases and/or in regions remains constant in the direction from the one radial end region to the other radial end region of the force transmission surface. There is preferably provision, in this case, for the force application portion to be arranged proximate the radially inner end region of the force application surface.

The object is further achieved by a friction clutch including a housing arrangement coupled or couplable to a drive member for joint rotation about an axis of rotation, a pressure plate which is fixedly coupled in terms of rotation to the housing arrangement and is axially displaceable with respect to the housing arrangement in the direction of the axis of rotation. A force accumulator supported in relation to the housing arrangement acts on the pressure plate, wherein the pressure plate has a first pressure force transmission surface. An intermediate plate may be coupled to the housing arrangement for joint rotation therewith. The intermediate plate has a second force transmission surface which is in or is capable of being brought into pressure force transmission contact with the first force transmission surface of the pressure plate. The intermediate plate being intended for absorbing a pressure force from the pressure plate. At least one force transmission surface of the first and second transmission surfaces is designed to be curved in a radial region thereof.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The invention is described in detail below with reference to the accompanying drawings in which:

FIG. 1 is a longitudinal sectional view of a friction clutch;

FIG. 2 is a perspective view of a pressure plate used in the friction clutch shown in FIG. 1;

FIG. 3 is an enlarged partial sectional view of a known pressure plate;

FIG. 4 is a graph showing a deformation path/force graph;

FIG. 5 is an enlarged partial sectional view of a pressure plate configured according to the present invention;

FIG. 6 is an enlarged partial sectional view of an alternative embodiment of a pressure plate according to the present invention; and

FIG. 7 is a partial longitudinal sectional view of an intermediate plate according to the invention which cooperates with a pressure plate.

### DETAILED DESCRIPTION OF THE PREFERRED) EMBODIMENTS

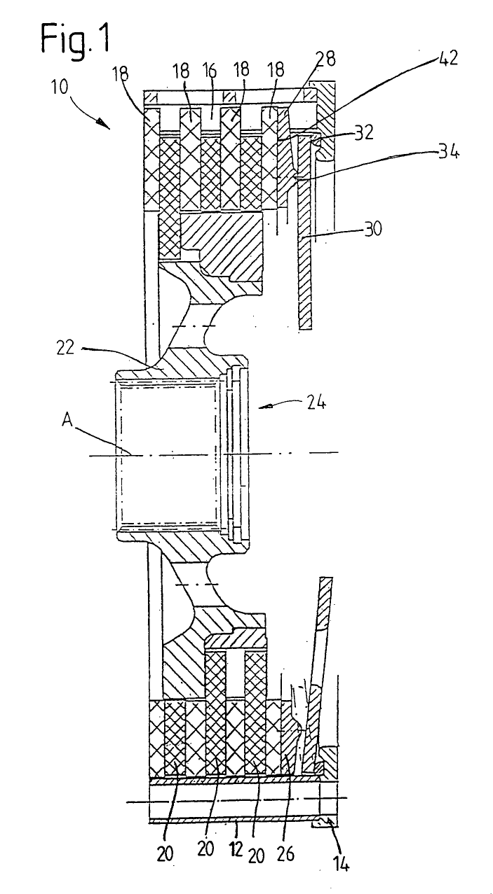

FIG. 1 discloses a friction clutch 10 which is a multiple-disk clutch. Friction clutches of this type are used, for example, in motor sports. The friction clutch 10 includes a housing arrangement 12 and a housing cover 14 fixedly connected on one axial end face thereof, with respect to an axis of rotation A, by a plurality of screw bolts (not shown) which are arranged so as to be distributed around the circumference. A radially inner side of the housing arrangement 12 includes a plurality of coupling projections 16 distributed in the circumferential direction and which extend in the axial direction. Outer disks 18 are in engagement with the coupling projections 16, so that the outer disks 18 are fixedly coupled to the housing arrangement 12 with respect to rotation, but axially displaceable with respect to the housing arrangement 12. A plurality of inner disks 20 are alternately arranged between the plurality of outer disks 18. These inner disks 20 are coupled to a hub arrangement 22 of a clutch disk arrangement 24 so that they are fixed with respect to rotation, but movably to some extent in the axial direction. The hub arrangement 22 may then be coupled fixedly in terms of rotation to a transmission input shaft or the like using a known connection.

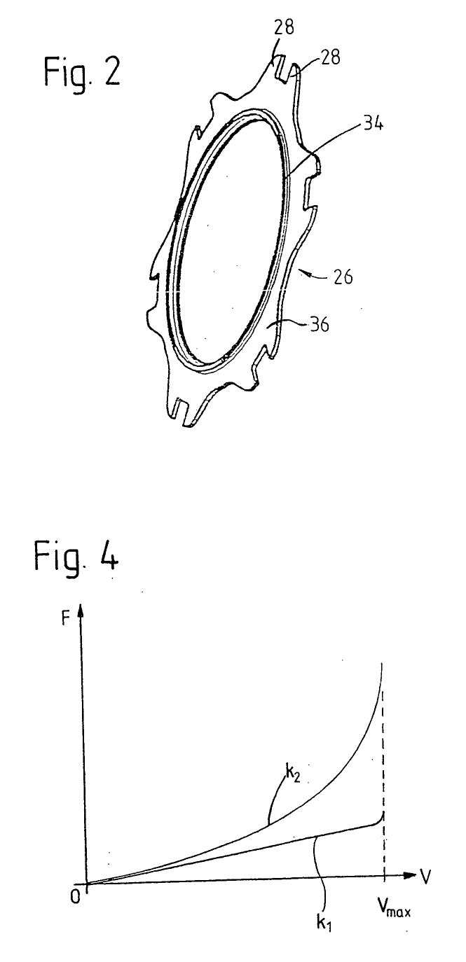

A pressure plate 26 of ring-shaped design is also coupled fixedly in terms of rotation to the housing arrangement 12 in the region of the projections 16, similarly to the outer disks 18. For this purpose, the pressure plate 26 has a plurality of coupling projections 28 distributed over an outer circumference thereof (see FIG. 2). A force accumulator 30 designed, for example, as a diaphragm spring is supported in its radially outer region on the housing cover 14 via a wire ring 32 or the like and acts radially further inward upon a knife-edge region 34 of the pressure plate. A disengagement mechanism for disengaging the friction clutch 10 may act with a tensioning effect on the radially inner end region of the force accumulator. In the engaged state, the force accumulator 30 acts upon the pressure plate 26 which transmits this application force to one of the outer disks 18 and consequently presses the outer disks 18 into frictional engagement with the inner disks 20. In this case, a flywheel mass arrangement, not illustrated, which may be fixedly connected to the housing arrangement 12 in the same way as the housing cover 14, forms an abutment. This flywheel mass arrangement may itself provide directly a friction surface cooperating with an inner disk 20, or may alternatively serve merely for the axial support of one of the outer disks 18 so that, in the same way as in the region of the pressure plate 26, there will be no circumferential frictional interaction with the next following disk, i.e., outer disk 18.

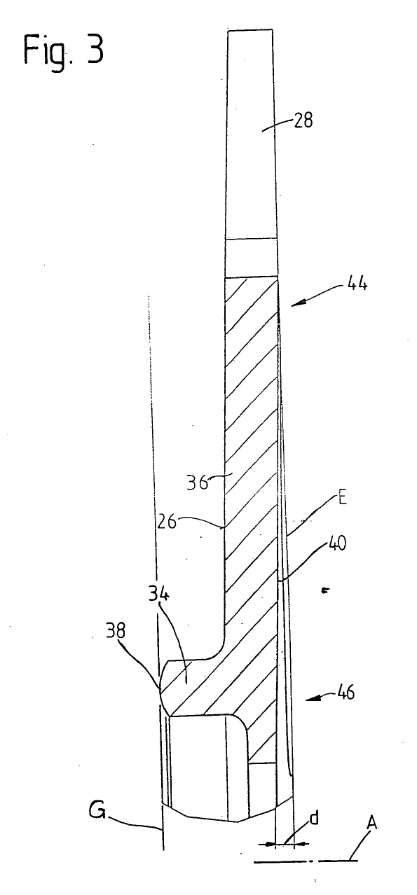

FIG. 3 is an enlarged view of a partial sectional view of a known pressure plate 26 which includes a ring-like pressure plate body 36 with a knife-edge region 34 formed on one axial side thereof. The knife-edge region 34 forms, with its vertex region, a supporting region 38, at which the force accumulator 30 acts upon the pressure plate 26. On the other axial side, the pressure plate 26 defines a force application surface 40. The force introduced into the pressure plate 26 by the force accumulator 30 is transmitted through the force application surface 40, in the case of the embodiment according to FIG. 1, to the outer disk 18 held fixedly in terms of rotation together with the pressure plate 26.

It can be seen in FIG. 3 that the pressure plate 26 is of umbrella-like design in the region of its force application surface 40. That is, this force application surface 40 runs at an inclination with respect to a plane E orthogonal to the axis of rotation A. This can also be seen, above all, from the distance d between the radially inner end region of this force application surface 40 and the imaginary plane E. In particular, the configuration is arranged such that the axial distance between the force application surface 40 and a plane G orthogonal to the axis of rotation and passing through the supporting region 38 decreases from the radially outward area to the radially inward area. During engagement of the clutch 10, the pressure plate 26 is slightly displaced axially by the force accumulator 30 and acted upon with force. The radially outer region of the pressure plate 26 will first contact with the outer disk 18 which directly follows the pressure plate 26 and which provides an essentially planar counterforce application surface 42, that is to say parallel to the plane E. After initial contact at the radially outer region, the pressure plate 26 is deformed under the force of the force accumulator 30 applied to the knife-edge region 34 or the supporting region 38 formed on it being positioned near the radially inner end region 46 of the force application surface 40, until the pressure plate 26, in the region of its ring-like pressure plate body 36, comes into full-area bearing contact with the outer disk 18. Owing to this elasticity present in the region of the pressure plate 26, the friction clutch 10 incorporates a function which, in conventional clutches, corresponds, in principle, to the function of lining resilience. That is to say, during the engagement operation, the pressure plate 26 provides, in the manner of lining resilience, an elasticity or counterforce which makes smooth coupling possible. The profile of this counterforce produced by the pressure plate in FIG. 3 is represented in FIG. 4 by the curve K₁. Starting at a deformation path V of zero, that is to say a state in which the pressure plate 26 is essentially not acted upon by the force accumulator 30, the counterforce which occurs is shown up to a maximum deformation path Vₘₐₓ. In the embodiment shown in FIG. 3, the force application surface 40 extends in a straight line and is inclined with respect to the plane E. The counterforce produced increases linearly with respect to the deformation path and bends sharply when or shortly before the maximum deformation path Vₘₐₓ is reached. Since there is then full-area bearing contact, further deformation is prevented and the counterforce or elasticity are also no longer generated in the region of the pressure plate 26.

This linear rise with a very sharp transition into the state in which deformation is no longer possible presents the problem that a highly accurately metered variation in the clutch torque is difficult in or near this transitional region. There is the risk that coupling jolts will occur or the risk that, because the rise in the clutch torque is too spontaneous, there will be an excessive surge in the engine rotational speed when the force accumulator 30 is continuously released.

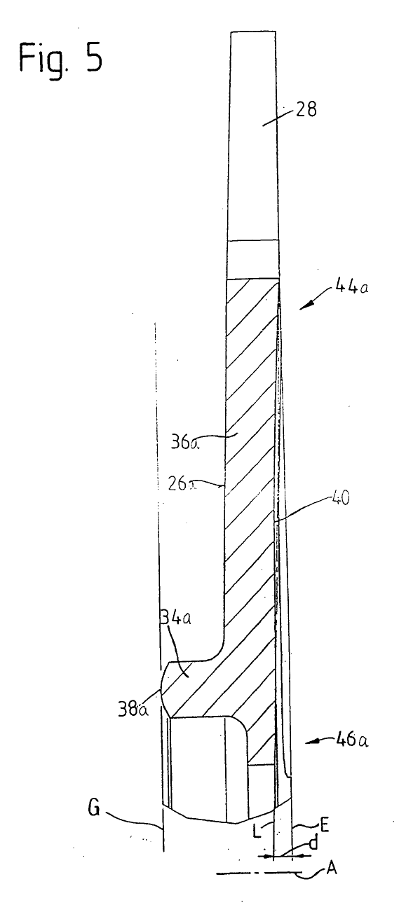

To counteract this problem, FIG. 5 shows a pressure plate 26a which is designed to overcome this problem. FIG. 5 shows that, a force application surface 40a provided in the pressure plate 26a according to the invention is curved with respect to a line L which runs at an inclination to the plane E and may correspond, for example, to the inclined profile of the force application surface 40 illustrated in FIG. 3. In the exemplary embodiment of FIG. 5, a concave curvature is provided. The curvature commences in the radially outer region of the force application surface 40a and preferably extends as far as the radially inner end region 46a where the force application surface 40a can then extend, in an end portion, along the line L extending rectilinearly. By means of this curvature of the force application surface 40a, in a similar way to the embodiment illustrated in FIG. 3, an umbrella-shaped pressure plate 26a or force application surface 40a of the latter is provided, which defines an elasticity or counterforce when an engagement operation is carried out. The curvature which is to be provided according to the invention and which thus extends approximately over the entire radial region of extent of the ring-like pressure plate body 36a, exhibits a force characteristic, such as is illustrated in FIG. 4 by the line K₂. It can be seen, here, that there is a marked deviation from a linear profile of the counterforce as a function of the deformation of the pressure plate 26. Instead, there is a progressive force profile, that is to say a force profile in which the gradient of the line K₂ increases continuously. In this way, the bend region which is seen in the curve K₁ at the approach to the maximum deformation path Vₘₐₓ, is avoided. Furthermore, a gradual transition into the state in which deformation will no longer occur is achieved, since the entire force application surface 40a bears on the counterforce application surface 42 of the outer disk 18 (see FIG. 1). This considerably improves the meterability of the clutch torque when an engagement operation is carried out. It becomes possible to set a defined clutch torque with high accuracy, so that the torque transmitted to the driving wheels and from these to the ground can be set or varied with correspondingly high accuracy. This is important, particularly in the motor racing sector, in the starting phase in which the driving wheels are to rotate with a defined drive slip.

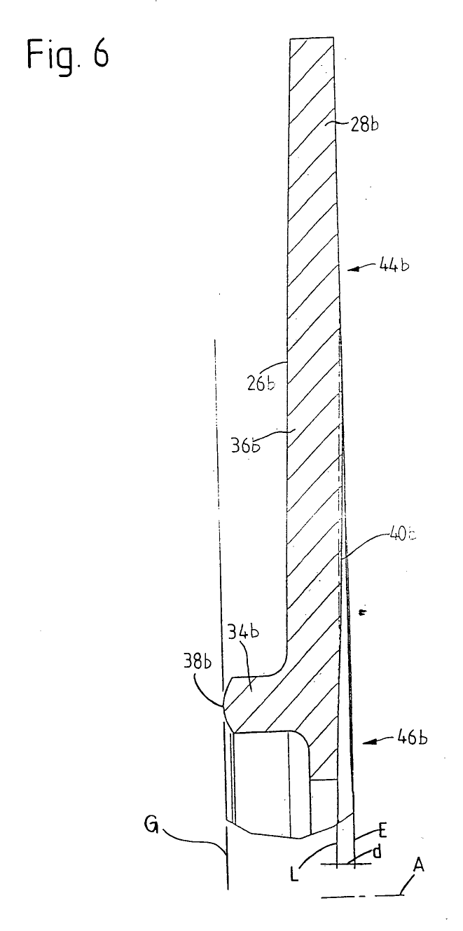

In the embodiment of a pressure plate 26b, as illustrated in FIG. 6, the force application surface 40b is curved convexly in its essential region of extent between the radially inner end region 46b and the radially outer end region 44b. Here again, the line L which, to form the distance d, runs at an inclination with respect to the plane E orthogonal to the axis of rotation A may be used as a reference line. The convex curvature also results in a force profile with a progressive characteristic, that is to say a gradient increasing constantly in the direction of the maximum deformation of the pressure plate 26. In the embodiment of FIG. 6, there may be provision for the radially inner end portion of the force application surface 40a, the end portion being the region overlapping radially with the knife-edge region 34, to be designed to run approximately parallel to the line L again. In both design variants illustrated in FIGS. 5 and 6, however, there is provision for the axial distance between plane G orthogonal to the axis of rotation A and passing through the supporting region 38a, 38b on the knife-edge region 34a, 34b and the force application surface 40a, 40b to decrease continuously from a radially outward side to a radially inward side, that is to say in relation to that region in which the knife-edge region is provided and therefore the force is introduced into the pressure plate 26a, 26b.

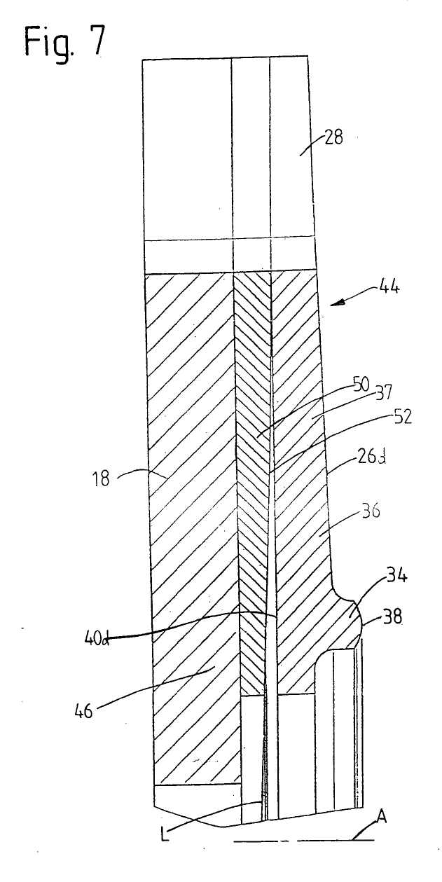

FIG. 7 illustrates an embodiment in which the same elasticity profile as shown by the curve K₂ in FIG. 4 can be obtained, in that a corresponding curvature is provided in the region of an intermediate plate 50. The pressure plate 26d acts upon the first outer disk 18 through the intermediate place 50. It may be pointed out, here, that, in this case, the pressure plate 26d is rotatable jointly with the intermediate plate 50 and with the first outer disk 18, that is to say there is no circumferential friction action generated between these three components. It would therefore also be conceivable, in principle, to provide the below-described shaping of the force application surface 52 of the intermediate plate 50 in the region of the outer disk 18, to be precise in the region of the counterforce application surface 42 of the latter.

In the embodiment illustrated in FIG. 7, the force application surface 40d of the pressure plate 26d is designed in such a way that it is essentially orthogonal to the axis of rotation A, that is to say lies parallel to the imaginary plane E referred to above. The force application surface 52 on a ring-like intermediate plate body 53 of the intermediate plate 50 is in this case of curved design, and here again, in the example illustrated, a convex curvature is provided with respect to the line L running at an inclination to the plane E. The obliquity or curvature of the force application surface 52 is such that the first contact between this force application surface 52 and the force application surface 40d of the pressure plate 26d will occur at the radially outer end region 44, whereas there is still an axial distance between the pressure plate 26d and the intermediate plate 50 at the radially inner end region 46, which is the region in which the knife-edge region 34 also lies. With an increasing application of force by the force accumulator, the pressure plate 26d will then come to bear with its force application surface 40d onto the force application surface 52 increasingly from radially outward to radially inward, there being generated, in turn, a counterforce which is induced as a result of the deformation of the pressure plate 26d and the profile of which also corresponds, in principle, to the profile K₂ in FIG. 4. Here too, therefore, a progressive counterforce rise is obtained, which ensures a very good meterability of the clutch in this phase.

It may be pointed out that it is also possible, of course, to combine the embodiment of FIG. 7 with the embodiments of FIGS. 5 and 6, so that there is obliquity or curvature both in an intermediate plate and in the pressure plate. The choice of the component or components on which there is a curvature or the extent of the curvature or the nature of the curvature may be selected as a function of the requirements applicable with regard to the counterforce or to the counterforce profile.

By a force application surface of a pressure plate or of an intermediate plate of a friction clutch being configured according to the invention, a friction clutch of this type, which is used particularly in the motor racing sector and is therefore subject to very high loads, even thermal loads, can incorporate an elastic function which corresponds essentially to the function of lining resilience in conventional friction clutches or clutch disks of the latter. However, the incorporation according to the invention of an elasticity of this kind provides a highly temperature-resistant and durable construction, and at the same time a further improvement in the properties can be achieved here by the choice of special construction materials, such as, for example, spring steel for the plate which undergoes deformation.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements which perform substantially the same function in substantially the same way to achieve the same results are within the scope of the invention. Moreover, it should be recognized that structures and/or elements shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A pressure force transmission plate for a friction clutch, comprising a ring-like plate body having first and second axial sides with respect to a plate axis of rotation A, said plate body defining a force transmission surface on said first axial side, wherein said force transmission surface comprises a curved surface in a radial region on said first axial side, said curved surface comprising one of a convex and a concave curved surface.

2. The pressure force transmission plate of claim 1, wherein said plate body further includes a force application portion for receiving a force provided by a force accumulator, said force application portion being arranged on said second axial side of said plate body.

3. The pressure force transmission plate of claim 2, wherein the force transmission surface includes a radially inner end region and a radially outer end region, said force application portion being arranged, in the radial direction, proximate one of the inner and outer radial end region of the force transmission surface, and wherein an axial distance between the force transmission surface and a plane orthogonal to the axis of rotation and passing through the force application portion increases from the one of the inner and outer radial end regions to the other of the inner and outer radial end regions.

4. The pressure force transmission plate of claim 3, wherein said force application portion is arranged, in the radial direction, proximate said radially inner end region of said force application surface.

5. A friction clutch, comprising:
a housing arrangement rotatable about an axis of rotation and connectable to a drive member;
a pressure plate fixedly connected to said housing arrangement with respect to rotation and displaceable relative to said housing arrangement in the direction of the axis of rotation A; and
a force accumulator supported with respect to said housing arrangement for exerting a force on said pressure plate, said pressure plate defining a pressure force transmission surface for transmitting the force received from the force accumulator, said pressure force transmission surface comprising a curved surface in a radial region thereof, said curved surface comprising one of a convex and a concave curved surface.

6. A friction clutch, comprising:
a housing arrangement rotatable about an axis of rotation and connectable to a drive member;
a pressure plate fixedly connected to said housing arrangement with respect to rotation and displaceable relative to said housing arrangement in the direction of the axis of rotation A;
a force accumulator supported with respect to said housing arrangement for exerting a force on said pressure plate, said pressure plate having a first pressure force transmission surface for transmitting the force received from the force accumulator; and
an intermediate plate coupled to said housing arrangement for joint rotation therewith, said intermediate plate having a second force transmission surface which movable into pressure force transmission contact with said first force transmission surface of said pressure plate, said second force transmission surface being intended for absorbing a pressure force from said pressure plate, at least one of said first and second force transmission surfaces comprising a curved surface in a radial region thereof, said curved surface comprising one of a convex and a concave curved surface.
